(19) United States
(12) Patent Application Publication
(10) Pub. No.: US 2006/0108514 A1
(43) Pub. Date: May 25, 2006

(54) Pulse modulation light detection device, electronic apparatus, and pulse modulation light detection method

(75) Inventor: Yasuhiro Maruyama, Katsuragi-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/283,776

(22) Filed: Nov. 22, 2005

(30) Foreign Application Priority Data
Nov. 24, 2004 (JP) 2004-339117

(51) Int. Cl. G06M 7/00

(52) U.S. Cl. 250/221

(57) ABSTRACT

A light emitting device for emitting pulse lights synchronized with a pulse signal is provided. A light receiving device for receiving the pulse lights reflected by or penetrating an object to be detected is provided. A signal processing circuit for detecting whether the object exists or not, based on a light receiving signal from the light receiving device. A synchronization timing circuit for generating the pulse signal used for emitting a plurality of pulse lights in one cycle is provided. The signal processing circuit detects the plurality of pulses and outputs a detection signal for indicating whether the object exists or not.

This non-provisional application claims priority under 35 U.S.C. § 119(a) on Patent Application No. 339117/2004 filed in Japan on Nov. 24, 2004, the entire contents of which are hereby incorporated by reference.

### FIELD OF THE INVENTION

The present invention relates to a pulse modulation light detection device and a pulse modulation light detection method, by which a pulse-modulated light is emitted from a light emitting device and whether or not an object exists is detected. Particularly, the present invention relates to a pulse modulation light detection device and a pulse modulation light detection method which are suitable for electronic devices such as FA (Factory Automation) and OA (Office Automation) apparatuses (e.g. copying machines and printers), and amusement apparatuses which detect coins and balls.

### BACKGROUND OF THE INVENTION

In electronic apparatuses such as FA and OA apparatuses (e.g. copying machines and printers), and amusement apparatuses (e.g. game machines), there is a case where it is necessary to detect passing of an object (recording paper, coin, ball, and the like) in a predetermined path. Light detection devices which detect an object with light are preferably used for such detection, because the devices can detect the object without touching it.

An example of conventional light detection devices is illustrated in FIG. 6. Further, a function timing chart at a time when a synchronized pulse light is incident in conventional art is illustrated in FIG. 7. In the light detection device, a basic clock (CLK) signal (A2) generated by an oscillating circuit 21 is modulated into a synchronization timing signal (B2) by a synchronization timing circuit 22. Based on the synchronization timing signal (B2), a light emitting device 24 is driven by a light emitting device driving circuit 23, and a pulse light which has been pulse-modulated is emitted from the light emitting device 24.

The pulse-modulated pulse light is reflected by or penetrates an object A which passes in front of/between the light emitting device 24 and a light receiving device 25, and is incident to the light receiving device 25. Therefore, as illustrated in FIG. 7, when there is no external disturbing light (C2) circumferentially (in FIG. 7, external disturbing light (C2) is in a Lo level), a pulse light incident to the light receiving device 25 is turned ON/OFF by passing of the object A that crosses the pulse light.

The pulse light whose incidence to the light receiving device 25 was turned ON/OFF is photoelectrically converted by the light receiving device 25 into a light receiving signal (D2), and the light receiving signal (D2) is amplified by an amplifier 26, has its waveform shaped by a judgment circuit 27, and is outputted as an output (E2) from the judgment circuit 27. The output (E2) is inputted to a signal processing circuit 28 and is subject to signal processing, and a signal processing circuit output signal (F2) is generated and outputted from the signal processing circuit 28. The signal processing circuit output signal (F2) is adjusted by an output circuit 29 so as to be suitable for output to outside, and is outputted by the output circuit 29 as a Hi signal or Lo signal which is a detection signal for showing whether the object A is detected or not (see Japanese Examined Patent Publication No. 53396/1992 (published on Jun. 12, 1987) and Japanese Examined Patent Publication No. 53273/1992 (published on Aug. 8, 1986)).

However, in the conventional arrangement, there is a problem that although the object A to be detected does not exist, the output circuit 29 alternately outputs Hi and Lo due to external disturbing light as if oscillation occurs, and therefore the object A is misdetected.

Representative external disturbing light is a light from an inverter fluorescent lamp. As illustrated in FIG. 8(a), a light from an inverter fluorescent lamp includes lights with a variety of strengths, and as an enlarged view in FIG. 8(b) illustrates, it is found that the light is constituted of a driving frequency indicated on an apparatus of an inverter fluorescent lamp and its harmonic waves. Generally known driving frequencies of an inverter fluorescent lamp are approximately from 40 kHz through 60 kHz.

FIG. 9 illustrates a timing chart in a case where the light from an inverter fluorescent lamp illustrated in FIGS. 8(a) or 8(b) is incident as an external disturbing light, when, in conventional art, there is no object A to be detected by the light detection device illustrated in the block diagram of FIG. 6.

When the light from the inverter fluorescent lamp is incident, the judgment output (E2) shows a lot of pulse lights, in comparison with the light emitting timing (B2). When the light from the inverter fluorescent lamp synchronizes with the light emitting timing, the light is misdetected as a synchronized light, and when the light from the inverter fluorescent lamp does not synchronize with the light emitting timing, or when strength of light-receiving weakens, the light is not detected as the synchronized light. Therefore, there is a problem that although the object A to be detected does not exist, the output circuit 29 alternately outputs Hi and Lo as if oscillation occurs, and accordingly the object A is misdetected.

Next, in the block diagram of the conventional art illustrated in FIG. 6 at the time of the misdetection, the signal processing circuit 28 is explained. One example of the signal processing circuit 28 is illustrated in FIG. 10. In the signal processing circuit 28, outputs E2 from the judgment circuit 27 are acquired with synchronization timing X2 and non-synchronization timing Z2 respectively. The signal processing circuit 28 is provided with (i) a synchronization latch circuit 2D and a non-synchronization latch circuit 2F each having a timing gate for maintaining an acquired output, (ii) a state detection circuit 2I which acquires outputs Q and Q⁻ (Q bar) respectively from the synchronization latch circuit 2D and the non-synchronization latch circuit 2F, and judges a state of a signal, and (iii) a shift register 2J.

Here, FIG. 11 illustrates a timing chart of the signal processing circuit 28 at a time when external disturbing light illustrated in FIG. 9 is incident. In comparison with the synchronization timing X2, the judgment output E2 shows a state where no signal exists and a state where a lot of pulse lights exist. In the state where a lot of pulse lights exist, when there is a pulse (judgment output E2) overlapping with the synchronization timing X2, the synchronization latch circuit 2D maintains the output until a latch reset timing. In the same way, when there is a pulse judgment output E2) overlapping with the non-synchronization timing Z2, the non-synchronization latch circuit 2F maintains the output until a latch reset timing.

Namely, the synchronization latch circuit 2D maintains an output signal during a time from overlapping of the signal of the judgment output E2 with the synchronization timing X2 to arrival of the latch reset timing. Further, the non-synchronization latch circuit 2F maintains an output during a time from overlapping of the signal of the judgment output E2 with the non-synchronization timing Z2 to arrival of the latch reset timing.

The output signals of the synchronization latch circuit 2D and the non-synchronization latch circuit 2F are inputted to the state detection circuit 2I, and the state detection circuit 21 outputs, according to its logic, a PRESET signal, a CLR signal, or a CLK signal to PRESET (S), CLR (R), or CLK of the shift register 2J, so as to cause the shift register 2J to count.

A state where no signal exists in the timing chart of FIG. 11, namely, a state where the output F2 of the shift register 2J does not exist, is maintained by inputting the CLR signal. When the signal of the judgment output E2 is inputted on account of noise of the inverter fluorescent lamp, the CLK signal is outputted from the state detection circuit 2I to the shift register 2J, and the shift register 2J counts three CLK signals, the shift register 2J inverts its output to Lo. After the output F2 of the shift register 2J maintains Lo output due to the PRESET signal, the signal of the judgment output E2 ceases to be inputted, and accordingly the shift register 2J starts counting CLK signals. The counting is cancelled by an input of the CLR signal to CLR of the shift register 2J even when noise is detected in the course of counting, and the output of the shift register 2J inverts to Hi.

There is a problem that when external disturbing light acting as noise is incident from the inverter fluorescent lamp illustrated in FIGS. 8(a) and 8(b), the output F2 of the shift register 2J illustrated in FIG. 11 repeatedly switches between Hi and Lo as if the output F2 oscillates, and accordingly malfunction occurs.

### SUMMARY OF THE INVENTION

The present invention is made in view of the foregoing problems, and its object is realizing a pulse modulation light detection device and a pulse modulation light detection method which can, even when external disturbing light exists, suppress malfunction caused by the external disturbing light, and realizing an electronic apparatus using the device and the method.

The pulse modulation light detection device according to the present invention emits, from a light emitting device, pulse lights synchronized with a pulse signal, and detects whether an object exists or not, based on a light receiving signal from a light receiving device which receives the pulse lights reflected by or penetrating the object, the pulse modulation light detection device comprising: a pulse generation circuit for generating the pulse signal used for emitting a plurality of pulse lights in one cycle; and a light receiving-side detection circuit for detecting a light receiving signal corresponding to the plurality of pulse lights, and for outputting a detection signal for indicating whether an object exists or not. It may be that in the arrangement, when the light receiving signals corresponding to the plurality of pulse lights are serially synchronized and detected in the number of counts preset by a shift register and the like, a Hi level signal or a Lo level signal is judged and outputted as the detection signal.

In the conventional art, there is one synchronization timing in one cycle, and when there is a signal synchronizing with the synchronization timing, it is determined that synchronization in one cycle occurs and signal processing is performed. When the number of the synchronization is equal to the number preset by the shift register, detection or non-detection is determined.

In the present invention, there are a plurality of synchronization timings in one cycle, and only when a signal is detected as a light receiving signal in at least two synchronization timings out of the plurality of synchronization timings, it is determined that synchronization occurs in one cycle and a detection signal is generated. Thereby whether an object exists or not can be determined.

As a result, with the arrangement, only when signals are detected in at least two synchronization timings out of the plurality of synchronization timings, it is determined that synchronization occurs in one cycle. Therefore, even if random noise light such as external disturbing light from an inverter fluorescent lamp exists, and even if a light receiving signal derived from the external disturbing light overlaps with one of at least two synchronization timings, it is possible to reduce possibility that the light receiving signal overlaps with the other one of at least two synchronization timings. As such, it is possible to suppress misdetection caused by the external disturbing light.

In order to achieve the foregoing objects, the electronic apparatus according to the present invention uses the pulse modulation light detection device.

In order to achieve the foregoing objects, the pulse modulation light detection method according to the present invention emits pulse lights synchronized with a pulse signal, and detects whether an object exists or not based on a light receiving signal obtained by receiving the pulse lights reflected by or penetrating the object which crosses a light path of the pulse lights, the pulse modulation light detection method comprising: a step of setting the emitted pulse lights so as to have two or more pulse intervals; and a step of detecting whether an object exists or not using a light receiving signal obtained from the pulse lights having the two or more pulse intervals.

With the method, it is detected whether an object exists or not based on the light receiving signal derived from the pulse lights having the two or more pulse intervals, and therefore it is possible to reduce misdetection of the object caused by random external disturbing light.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a circuit block diagram illustrating one embodiment of the pulse modulation light detection device according to the present invention.

FIG. 2 is a circuit block diagram illustrating a signal processing circuit of the pulse modulation light detection device.

FIG. 3 is a timing chart illustrating signals of each section in the pulse modulation light detection device in a case where external disturbing light does not exist.

FIG. 4 is a timing chart illustrating signals of each section in the pulse modulation light detection device in a case where external disturbing light is incident.

FIG. 5 is a timing chart illustrating signals of each section of the signal processing circuit in a case where external disturbing light is incident.

FIG. 6 is a circuit block diagram illustrating a conventional pulse modulation light detection device.

FIG. 7 relates to conventional art and is a timing chart illustrating only synchronized signals.

FIG. 8(a) is a waveform view illustrating a waveform of light of an inverter fluorescent lamp.

FIG. 8(b) is an enlarged view of the waveform.

FIG. 9 relates to conventional art and is a timing chart in a case where external disturbing light is incident.

FIG. 10 is a circuit block diagram illustrating a signal processing circuit in the conventional pulse modulation light detection device.

FIG. 11 is a timing chart illustrating signals of each section of the signal processing circuit in the conventional techniques.

### DESCRIPTION OF THE EMBODIMENTS

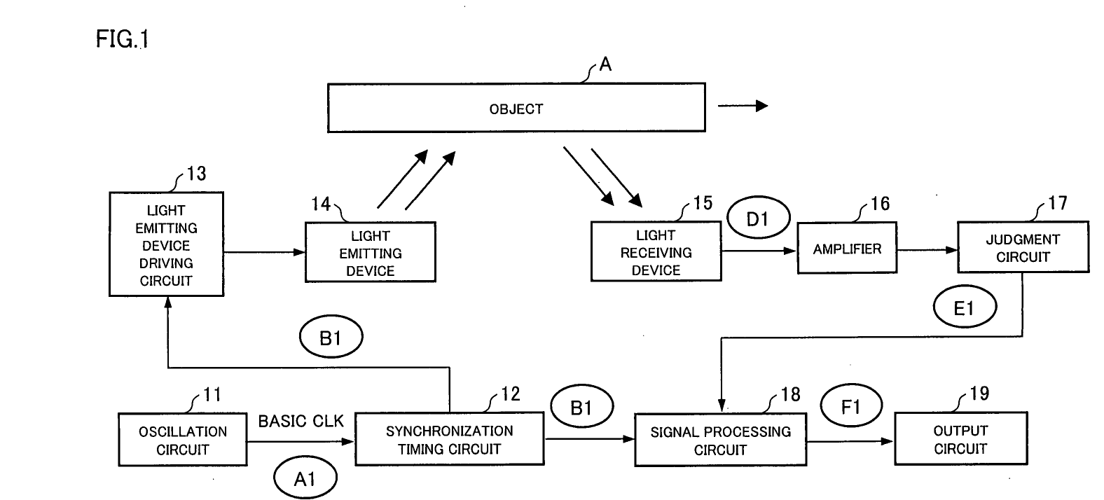

One embodiment of the pulse modulation light detection device and the pulse modulation light detection method according to the present invention is explained below with reference to FIGS. 1 through 5. As illustrated in FIG. 1, the pulse modulation light detection device of the present embodiment is provided with: an oscillation circuit 11 which has a crystal oscillator and the like, and generates and outputs a basic clock (abbreviated as CLK hereinafter) signal (A1) with a predetermined wavelength; and a synchronization timing circuit (pulse generating circuit) 12 for generating a light emitting timing pulse signal (B1) (pulse signal) based on the basic CLK signal.

Further, the pulse modulation light detection device is provided with: a light emitting device driving circuit 13 for generating a light emitting device driving signal corresponding to the light emitting timing pulse signal (pulse signal); and a light emitting device 14 for emitting, based on the light emitting device driving signal, a light synchronized with the light emitting timing pulse signal (pulse signal), in a predetermined direction (a direction of passing of an object A to be detected).

Further, the pulse modulation light detection device is provided with: a light receiving device 15 for receiving a light reflected on or passing through the object A to be detected, converting the light into a light receiving signal (D1) which is a corresponding detection electric signal, and outputting the light receiving signal (D1); an amplifier 16 for amplifying the light receiving signal (D1) supplied from the light receiving device 15 and outputting the signal as an amplified light receiving signal; and a judgment circuit 17 for detecting the pulse signal from the amplified light receiving signal and outputting the pulse signal as a judgment output signal (E1).

In addition, the pulse modulation light detection device is provided with: a signal processing circuit (light receiving-side detection circuit) 18 for comparing the judgment output signal (E1) with the light emitting timing pulse signal (B1) (pulse signal) and outputting a judgment processing signal (F1) which indicates, based on the counts of the judgment output signal (E1), whether the object A is detected or not; and an output circuit 19 for outputting the judgment processing signal (F1) after adjustment (such as low impedance and suitable output level) of the signal so that the signal is suitable for output to outside. It is preferable that the pulse modulation light detection device detects whether or not an object exists, based on a plurality of counts (for example, 3) of the judgment output signal (E1) which is the light receiving signal.

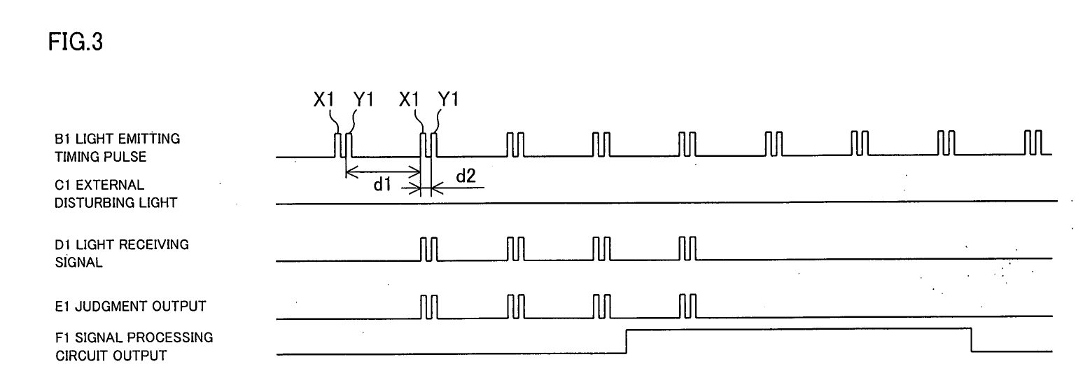

As illustrated in FIG. 3, the synchronization timing circuit 12 generates light emitting timing pulses (light emitting timing pulses with a plurality of pulse intervals) for emitting a plurality of pulse lights in one cycle. Further, the signal processing circuit 18 can detect pulses corresponding to the light emitting timing pulses in the judgment output signal (E1) which are the light receiving signals.

Therefore, in the pulse modulation light detection device, there are a plurality of (e.g. two) synchronization timings in one cycle of the judgment output signals (E1), and when synchronization occurs in, for example, three consecutive cycles in the shift register 1J, a Hi signal or Lo signal is outputted as a detection signal. Further, FIG. 3 illustrates a function timing chart (pulse modulation light detection method according to the present embodiment) in a case where the external disturbing light does not exist in the embodiment of the present invention, when a synchronized pulse light is incident.

Next, the function of the pulse modulation light detection device is explained. The basic clock signal (A1) is generated by the oscillation circuit 11, and modulated by the synchronization timing circuit 12 into a light emitting timing pulse signal (B1) having two synchronization timings in one cycle. The light emitting device driving circuit 13 drives the light emitting device 14 based on the light emitting timing pulse signal (B1), and the light emitting device 14 projects (emits) pulse-modulated pulse lights onto a position where the object A passes.

The pulse-modulated pulse lights are reflected by or penetrate the object A which passes in front of or between the light emitting device 14 and the light receiving device 15. Therefore, when there is no external disturbing light (C1) circumferentially, the pulse lights incident to the light receiving device 15 are turned ON/OFF by the passing of the object A.

The pulse lights are photoelectrically converted by the light receiving device 15 into the light receiving signal (D1), and the light receiving signal (D1) is amplified by the amplifier 16. The amplified light receiving signal has its waveform shaped and outputted as the judgment output signal (E1) by the judgment circuit 17. The judgment output signal (E1) is processed by the signal processing circuit 18 (F1), and outputted by the output circuit 19 as a detection signal being a Hi signal or Lo signal.

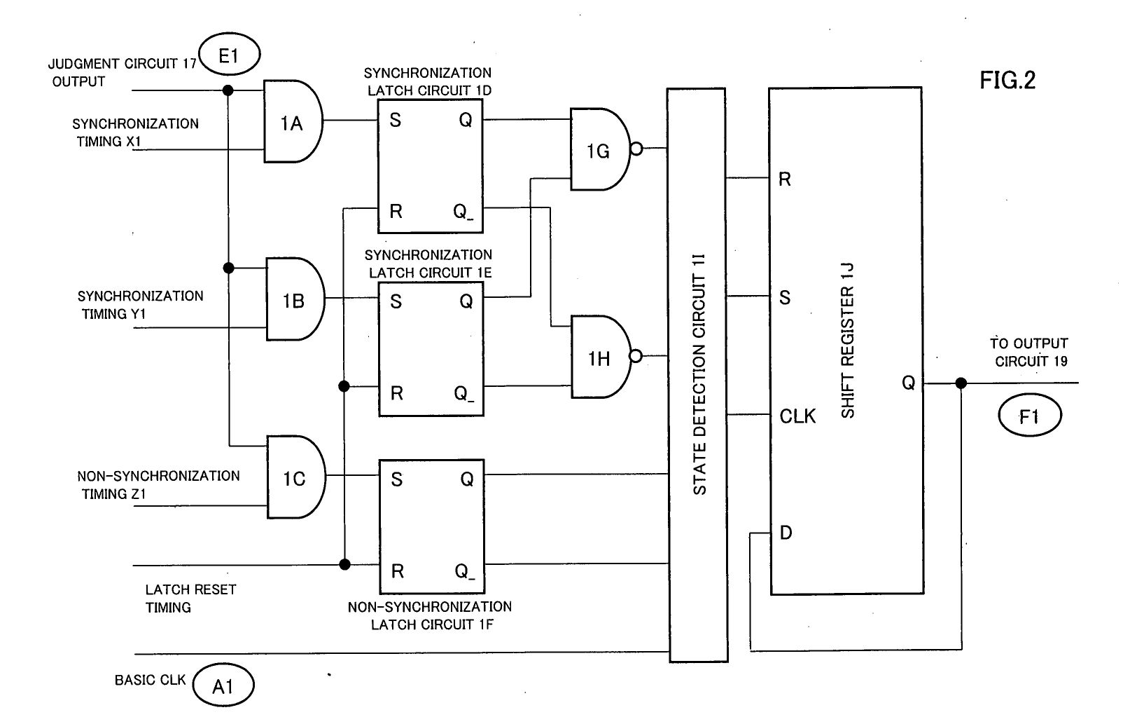

FIG. 2 illustrates one example of such a signal processing circuit 18. The signal processing circuit 18 is provided with AND circuits 1A, 1B, and 1C for acquiring a judgment output signal E1 from the judgment circuit 17, with synchronization timings X1 and Y1, and a non-synchronization timing Z1 respectively. The synchronization timings X1 and Y1 are synchronized with a light emitting timing pulse signal for emitting a plurality of (two in the present embodiment) pulse lights in one cycle. The non-synchronization timing Z1 is set so as not to be synchronized with the light emitting timing pulse signal, namely, not to overlap with the light emitting timing pulse signal.

Further, the signal processing circuit 18 is provided with synchronization latch circuits 1D and 1E and a non-synchronization latch circuit 1F, each having a timing gate for maintaining an output of AND circuits 1A, 1B, or 1C. The signal processing circuit 18 is further provided with a NAND circuit 1G to which outputs Q from the synchronization latch circuits 1D and 1E are inputted, and with a NAND circuit 1H to which outputs Q⁻ from the synchronization latch circuits 1D and 1E are inputted.

In addition, the signal processing circuit 18 is provided with: a state detection circuit 1I that acquires an output from the NAND circuit 1G, an output from the NAND circuit 1H, and outputs Q and Q⁻ from the non-synchronization latch circuit 1F, and that judges the state of the signal from the judgment circuit 17; and a shift register 1J.

The state detection circuit 1I may be any logic circuit that can detect the states of signals by using a logic capable of judging the states of signals, and the structure of the circuit is not particularly limited. Two examples of such logic are explained below. However, a logic other than them may be used.

One example of the logic is such that, in a state where external disturbing light does not exist (Q of the non-synchronization latch circuit 1F is 0), when synchronized light is incident at a non-detection time (Q of the shift register 1J is 1), the output of the NAND circuit 1G becomes 0, and accordingly the state detection circuit 1I outputs “1” to CLK of the shift register 1J. Further, in the logic, at a detection time (Q of the shift register 1J is 0), when synchronized light is incident, the output of the NAND circuit 1G becomes 0, and accordingly the state detection circuit 1I outputs “1” to PRESET of the shift register 1J (set (S) in FIG. 2). Further, in the logic, when synchronized light does not exists at the detection time (Q of the shift register J is 0), the output of the NAND circuit 1G becomes 1, and accordingly the state detection circuit 1I outputs “1” to CLK of the shift register 1J. Further, in the logic, when synchronized light does not exist at the non-detection time (Q of the shift register 1J is 1), the output of the NAND circuit 1G becomes “1”, and accordingly the state detection circuit 1I outputs “1,” to CLR (reset (R) in FIG. 2) and resets the shift register 1J.

The other example of the logic is such that, in a state where external disturbing light does not exist (Q of the non-synchronization latch circuit 1F is 0), when synchronized light does not exist at a non-detection time, the output of the NAND circuit 1G becomes 1, and accordingly the state detection circuit 1I outputs “1” to CLK of the shift register 1J. When synchronized light does not exist at a detection time (Q of the shift register 1J is 1), the output of the NAND circuit 1G becomes 1, and accordingly the state detection circuit 1I outputs “1” to CLR (reset (R) in FIG. 2) of the shift register 1J. When synchronized light is incident at the detection time (Q of the shift register 1J is 1), the output of the NAND circuit 1G becomes 0, and accordingly the state detection circuit 1I outputs “1” to CLK of the shift register 1J. When synchronized light is incident at the non-detection time (Q of the shift register 1J is 0), the output of the NAND circuit 1G becomes 0, and accordingly the state detection circuit 1I outputs “1” to PRESET (set (S) in FIG. 2) of the shift register 1J.

The shift register 1J may be any logic circuit that can maintain an input value (data), and clear (reset) the maintained input value according to necessity. D flip-flop, JK flip-flop and the like can be used for the shift register 1J. In the present embodiment, three stages of D flip-flops constitute the shift register 1J.

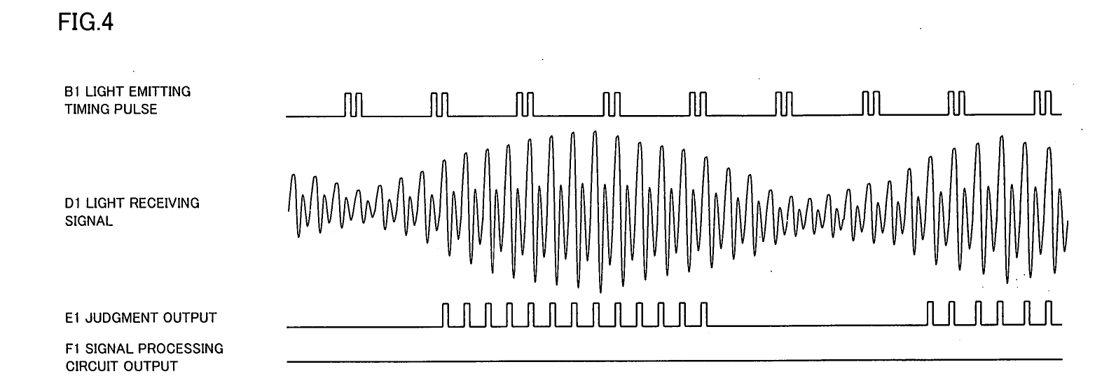

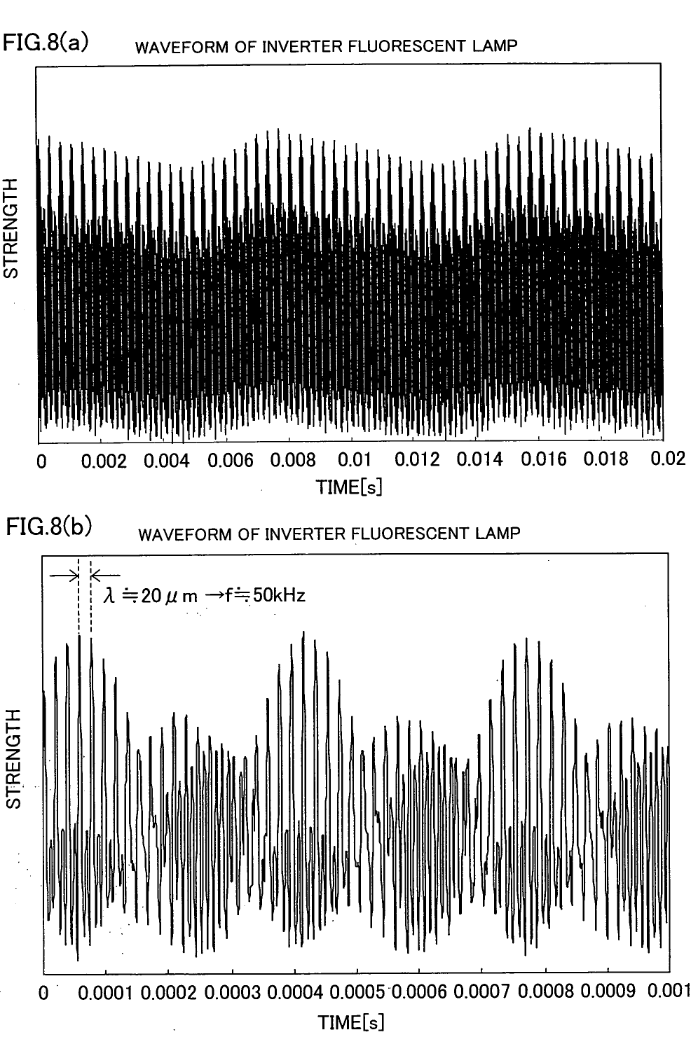

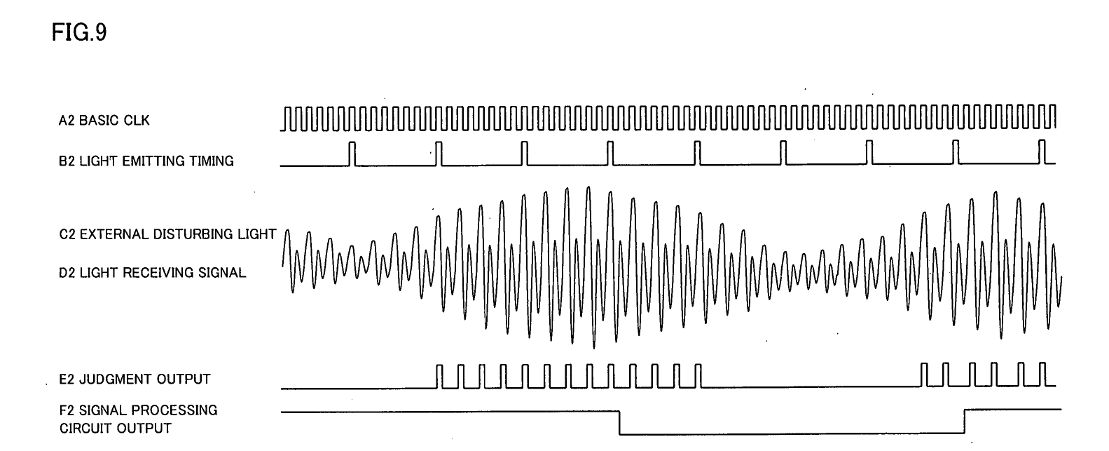

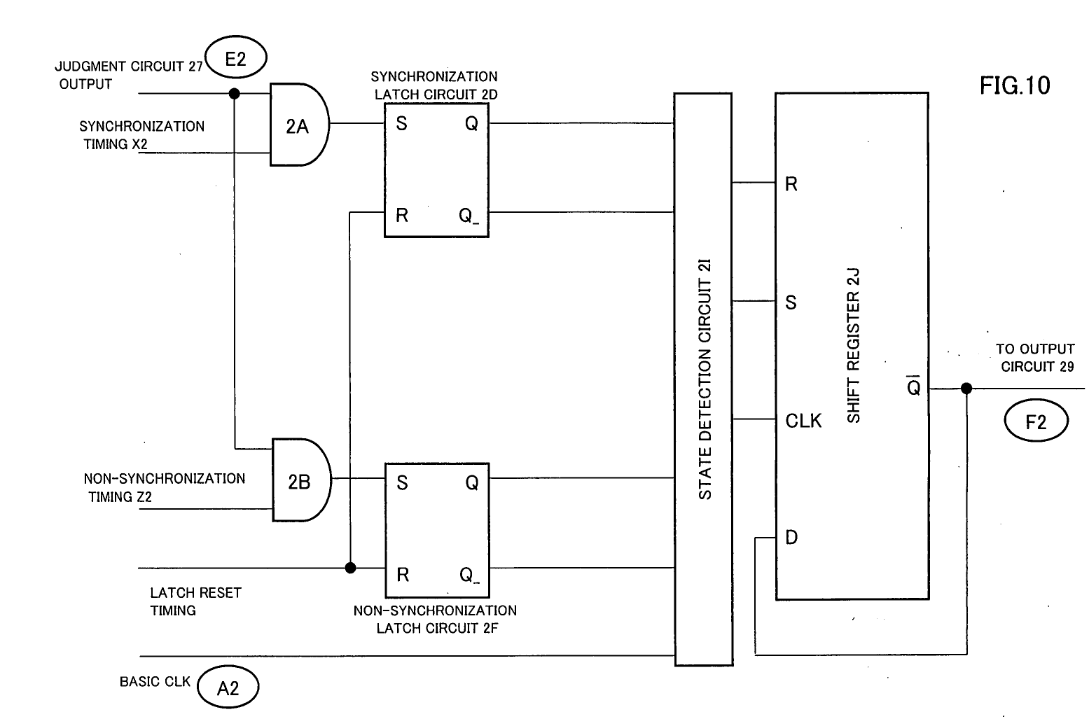

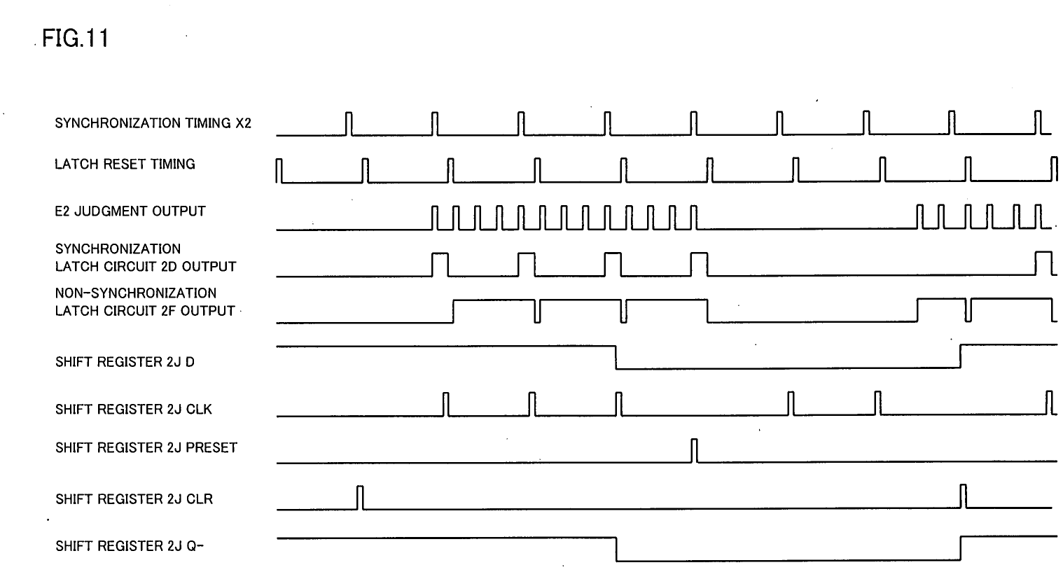

FIG. 4 illustrates a timing chart in a case where a synchronized pulse light is not incident in the pulse modulation light detection device illustrated by the circuit block diagram of FIG. 1, and where the light of an inverter fluorescent lamp illustrated in FIGS. 8(a) and 8(b) is incident as external disturbing light.

When the light of an inverter fluorescent lamp is incident, the judgment output signal (E1) shows presence of many pulse lights in comparison with the light emitting timing pulse signal (B1). In the present embodiment, when the judgment output signal (E1) does not overlap with at least one of two synchronization timings (light emitting timing pulse (B1)) in one cycle, synchronization in one cycle is not acknowledged. As for the cycle of an inverter fluorescent lamp, the judgment output signal (E1) cannot overlap with a synchronization timing serially two times, and accordingly synchronization is not acknowledged. Therefore, non-detection can be maintained without malfunction.

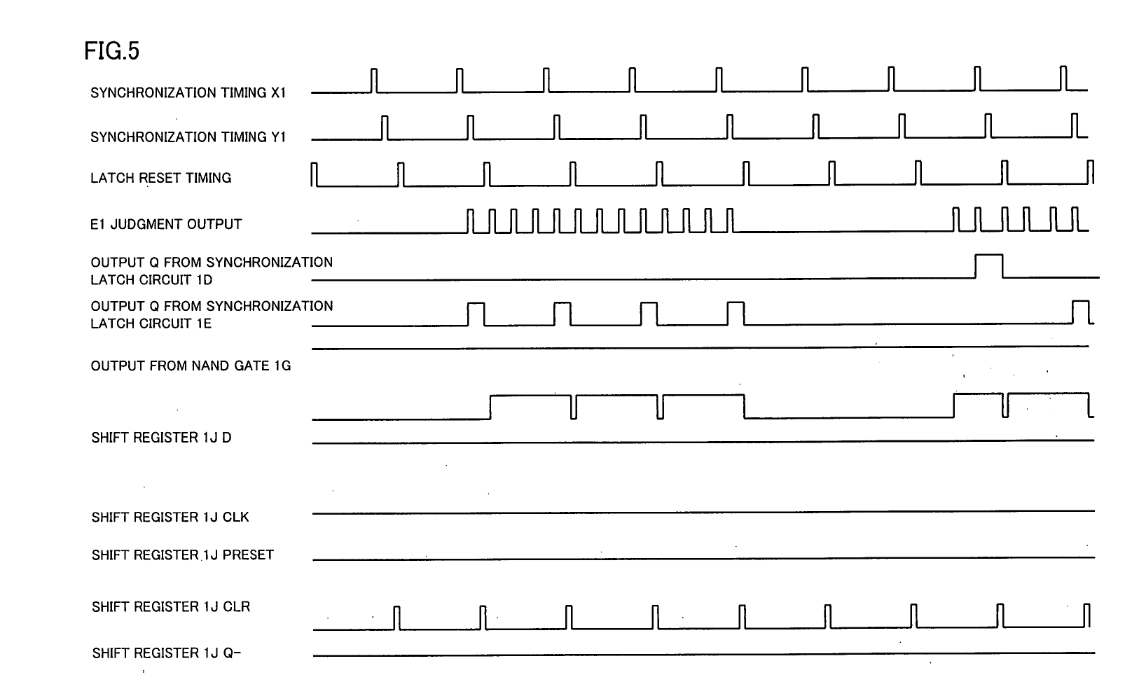

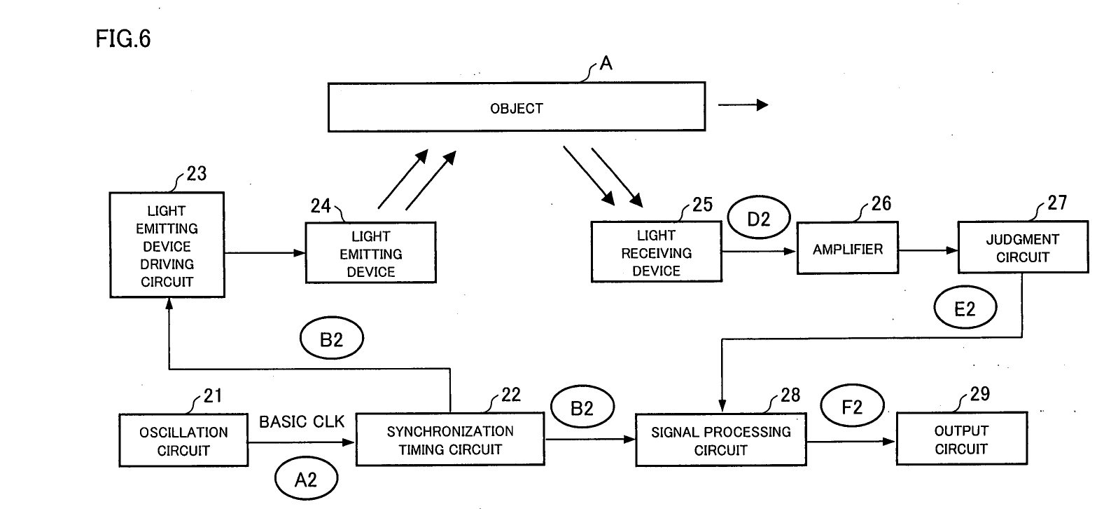

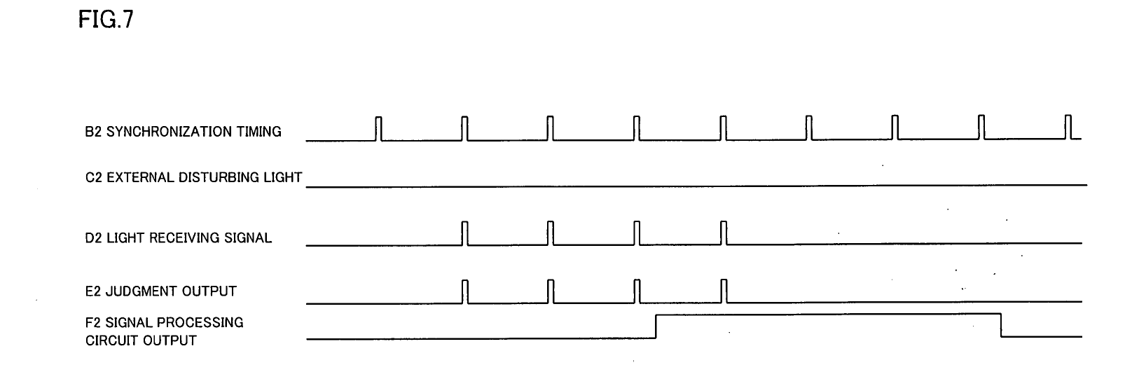

Here, FIG. 5 illustrates a timing chart of the signal processing circuit 18 in a case where external disturbing light illustrated in FIG. 4 is incident. In comparison with synchronization timing X1, the judgment output E1 shows a state where no signal exists and a state where a signal indicating many pulse lights exist. The light emitting timing pulse signal B1 is constituted of the synchronization timing X1 and the synchronization timing Y1, and when a pulse overlapping with the synchronization timing X1 exists, the synchronization latch circuit 1D maintains output until a latch reset timing.

In the same way, when a pulse overlapping with the synchronization timing Y1 exists, the synchronization latch circuit 1E maintains output until a latch reset timing. Further, when a pulse overlapping with the non-synchronization timing Z1 exists, the non-synchronization latch circuit 1F maintains output until a latch reset timing. Noise of the inverter fluorescent lamp may overlap with the synchronization timing X1 or the synchronization timing Y1, but the noise does not overlap with both of the synchronization timing X1 and the synchronization timing Y1 in one cycle, and therefore the NAND circuit 1G to which outputs Q from the synchronization latch circuits 1D and 1E are inputted always outputs a signal “1”, being a Hi level. Therefore, the state detection circuit 1I outputs “1” to R being CLR of the shift register 1J according to the logic and resets the shift register 1J, and accordingly can maintain non-detection without malfunction caused by the external disturbing light.

It is preferable that a synchronization timing interval in one cycle is faster (shorter) than the cycle of an inverter fluorescent lamp, which is 40 through 60 kHz (A=25 μm through 16.7 μm). When the light of an inverter fluorescent lamp is strongly incident, a second harmonics component in one cycle may appear in an output from the judgment circuit 17, and therefore it is preferable that the synchronization timing interval in one cycle is more than two times faster (more than half shorter) than the interval of the inverter fluorescent lamp, which is 40 through 60 kHz (A=25 μm through 16.7 μm). Further, upper limit of synchronization timing interval in one cycle is not particularly limited, but the upper limit is up to 10 times as large as the cycle of the inverter fluorescent lamp, more preferably up to 8 times, and further preferably up to 5 times.

Further, it may be that when external disturbing light is other than the inverter fluorescent lamp, the synchronization timing interval in one cycle is set so as to be faster than the frequency of the external disturbing light.

The present embodiment is explained with synchronization timings in one cycle being two, but the frequency of synchronization timings may be more than two so far as the frequency of base clocks constituting one cycle permits, and the more frequent the synchronization timings are, the more reduced malfunction is. Note that because the frequency of driving the light emitting device 14 is the same as the number of synchronization timings, the more frequent synchronization timings are, the more increased consumption of electric power is.

As described above, in the pulse modulation light detection device, it is possible to prevent malfunction in a case where external disturbing light such as the light of an inverter fluorescent lamp is incident.

Further, it is preferable that in the pulse modulation light detection device according to the present invention, the light receiving-side detection circuit includes a plurality of synchronization detection latch circuits corresponding to respective pulse lights, and when a signal synchronized with the synchronization detection latch circuits is detected, the light receiving-side detection circuit outputs the detection signal.

Further, it is preferable that the pulse generation circuit of the pulse modulation light detection device sets a frequency of pulse lights, which are emitted plural times in one cycle, to be larger than that of an assumed noise signal.

With the arrangement, the frequency of the pulse lights, which are emitted plural times in one cycle, is set so as to be larger than that of the assumed noise signal. Therefore, even if a light receiving signal derived from the external disturbing light overlaps with one of at least two synchronization timings, overlapping of the light receiving signal with the other one of synchronization timings can be surely reduced. As a result, misdetection caused by the external disturbing light can be surely suppressed.

It may be that the light receiving-side detection circuit includes a judgment section for judging that, when synchronization serially occurs in a plurality of cycles, an object is detected.

With the arrangement, when synchronization occurs in consecutive cycles, it is determined that an object is detected. Even if synchronization is caused by random noise light such as external disturbing light in one cycle, probability that synchronization occurs in the consecutive cycles is smaller than probability that synchronization occurs in one cycle, and therefore misdetection caused by the noise light can be safely reduced.

Further, in the pulse modulation light detection method according to the present embodiment, it is preferable that an assumed interval of the external disturbing light locates in at least one of two or more pulse intervals of the emitted pulse lights.

With the method, it is possible that the assumed interval of the external disturbing light locates in the at least one of two or more pulse intervals of the emitted pulse lights, while it is possible to make another one of two or more pulse intervals shorter than the assumed interval of external disturbing light. Therefore, even if one of pulse lights between which the another one pulse interval is provided synchronizes with, namely, overlaps with one of the external disturbing lights, it is possible to reduce possibility of synchronization (overlapping) of the other one of the pulse lights between which the another one pulse interval is provided, with another one of the external disturbing lights. As a result, it is possible to surely suppress misdetection of an object caused by external disturbing light. Note that the one of two or more intervals indicates a pulse interval dl between a rise of synchronization timing Y1 of a light emitting timing pulse B1 and a rise of synchronization timing X1 of a next light emitting timing pulse B1 illustrated in FIG. 3. The another one of two or more pulse intervals indicates a pulse interval D2 between a rise of synchronization timing X1 of a light emitting timing pulse B1 and a rise of synchronization timing Y1 of the light emitting timing pulse B1 illustrated in FIG. 3.

Further, it may be so arranged that the pulse modulation light detection method detects whether an object exists or not, based on a light receiving signal derived from pulse lights whose pulse interval is different from a widest pulse interval out of the two or more pulse intervals.

With the arrangement, by using the pulse lights whose pulse interval is different from a widest pulse interval out of the two or more pulse intervals, it is possible to cause at least one pulse interval out of the two or more pulse intervals to be shorter than the assumed interval of external disturbing light. As a result, it is possible to surely suppress misdetection of an object caused by external disturbing light.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A pulse modulation light detection device, which emits, from a light emitting device, pulse lights synchronized with a pulse signal, and detects whether an object exists or not, based on a light receiving signal from a light receiving device which receives the pulse lights reflected by or penetrating the object,
said pulse modulation light detection device comprising:
a pulse generation circuit for generating the pulse signal used for emitting a plurality of pulse lights in one cycle; and
a light receiving-side detection circuit for detecting a light receiving signal corresponding to the plurality of pulse lights, and for outputting a detection signal for indicating whether the object exists or not.

2. The pulse modulation light detection device as set forth in claim 1, wherein the light receiving-side detection circuit includes a plurality of synchronization detection latch circuits corresponding to respective pulse lights, and when a signal synchronized with the synchronization detection latch circuits is detected, the light receiving-side detection circuit outputs the detection signal.

3. The pulse modulation light detection device as set forth in claim 1, wherein the pulse generation circuit sets a frequency of pulse lights, which are emitted plural times in one cycle, to be larger than that of an assumed noise signal.

4. The pulse modulation light detection device as set forth in claim 2, wherein the pulse generation circuit sets a frequency of pulse lights, which are emitted plural times in one cycle, to be larger than that of an assumed noise signal.

5. The pulse modulation light detection device as set forth in claim 1, wherein the light receiving-side detection circuit includes a judgment section which judges that an object is detected, when a plurality of detection signals obtained from serial synchronization in a plurality of cycles are detected.

6. The pulse modulation light detection device as set forth in claim 2, wherein the light receiving-side detection circuit includes a judgment section which judges that an object is detected, when a plurality of detection signals obtained from serial synchronization in a plurality of cycles are detected.

7. The pulse modulation light detection device as set forth in claim 3, wherein the light receiving-side detection circuit includes a judgment section which judges that an object is detected, when a plurality of detection signals obtained from serial synchronization in a plurality of cycles are detected.

8. The pulse modulation light detection device as set forth in claim 4, wherein the light receiving-side detection circuit includes a judgment section which judges that an object is detected, when a plurality of detection signals obtained from serial synchronization in a plurality of cycles are detected.

9. An electronic apparatus, using a pulse modulation light detection device which emits, from a light emitting device, pulse lights synchronized with a pulse signal, and detects whether an object exists or not, based on a light receiving signal from a light receiving device which receives the pulse lights reflected by or penetrating the object,
said electronic apparatus using a pulse modulation light detection device comprising:
a pulse generation circuit for generating the pulse signal used for emitting a plurality of pulse lights in one cycle; and
a light receiving-side detection circuit for detecting a light receiving signal corresponding to the plurality of pulse lights, and for outputting a detection signal for indicating whether the object exists or not.

10. The electronic apparatus as set forth in claim 9, wherein the light receiving-side detection circuit includes a plurality of synchronization detection latch circuits corresponding to the respective pulse lights, and when a signal synchronized with the synchronization detection latch circuits is detected, the light receiving-side detection circuit outputs the detection signal.

11. The electronic apparatus as set forth in claim 9, wherein the pulse generation circuit sets a frequency of pulse lights, which are emitted plural times in one cycle, to be larger than that of an assumed noise signal.

12. The electronic apparatus as set forth in claim 10, wherein the pulse generation circuit sets a frequency of pulse lights, which are emitted plural times in one cycle, to be larger than that of an assumed noise signal.

13. The electronic apparatus as set forth in claim 9, wherein the light receiving-side detection circuit includes a judgment section which judges that an object is detected, when a plurality of detection signals obtained from serial synchronization in a plurality of cycles are detected.

14. The electronic apparatus as set forth in claim 10, wherein the light receiving-side detection circuit includes a judgment section which judges that an object is detected, when a plurality of detection signals obtained from serial synchronization in a plurality of cycles are detected.

15. The electronic apparatus as set forth in claim 11, wherein the light receiving-side detection circuit includes a judgment section which judges that an object is detected, when a plurality of detection signals obtained from serial synchronization in a plurality of cycles are detected.

16. The electronic apparatus as set forth in claim 12, wherein the light receiving-side detection circuit includes a judgment section which judges that an object is detected, when a plurality of detection signals obtained from serial synchronization in a plurality of cycles are detected.

17. A pulse modulation light detection method, in which pulse lights synchronized with a pulse signal are emitted, and whether an object exists or not is detected, based on a light receiving signal obtained by receiving the pulse lights reflected by or penetrating the object which crosses a light path of the pulse lights,
said pulse modulation light detection method comprising:
a step of setting the emitted pulse lights so as to have two or more pulse intervals; and
a step of detecting whether an object exists or not using a light receiving signal obtained from the pulse lights having the two or more pulse intervals.

18. The pulse modulation light detection method as set forth in claim 17, wherein an assumed interval of external disturbing light locates in at least one of two or more pulse intervals of the emitted pulse lights.

19. The pulse modulation light detection method as set forth in claim 17, wherein whether an object exists or not is detected, based on a light receiving signal derived from pulse lights whose pulse interval is different from a widest pulse interval out of the two or more pulse intervals.

20. The pulse modulation light detection method as set forth in claim 18, wherein whether an object exists or not is detected, based on a light receiving signal derived from pulse lights whose pulse interval is different from a widest pulse interval out of the two or more pulse intervals.
